(19) United States
(12) Patent Application Publication
(10) Pub. No.: US 2017/0243279 A1
(43) Pub. Date: Aug. 24, 2017

(54) SYSTEMS AND METHODS FOR REORDERING OF DISCARDED PRODUCTS

(71) Applicant: Wal-Mart Stores, Inc., Bentonville, AR (US)

(72) Inventors: John P. Thompson, Bentonville, AR (US); Donald R. High, Noel, MO (US); Michael D. Atchley, Springdale, AR (US)

(21) Appl. No.: 15/433,286

(22) Filed: Feb. 15, 2017

Related U.S. Application Data
(60) Provisional application No. 62/297,746, filed on Feb. 19, 2016.

(51) Int. Cl. G06Q 30/06; G01G 23/36; G01G 19/414

(52) U.S. Cl. CPC G06Q 30/0633; G01G 19/414; G01G 23/36

(57) ABSTRACT

In some embodiments, a receptacle for storing one or more products discarded by a consumer includes a side wall defining a receptacle opening for receiving a product, a closed bottom end, and an interior cavity configured to retain the product. The receptacle may include a product detecting sensor configured to detect the product proximate the receptacle opening, a product weight sensor configured to detect a weight of the product retained in the interior cavity, and a control unit in communication with the product detecting sensor and the product weight sensor. The control unit may be configured to obtain sensor data from the product detecting sensor and the product weight sensor, identify the product based on the obtained sensor data, and add the identified product to a shopping list of the consumer. Methods of adding a product discarded by a consumer to a shopping list of the consumer are also described.

### RELATED APPLICATIONS

This application claims the benefit of U.S. Provisional Application No. 62/297,746, filed Feb. 19, 2016, which is incorporated herein by reference in its entirety.

### TECHNICAL FIELD

This invention relates generally to reordering products previously ordered by a consumer and, in particular, to systems and methods of adding a product discarded by a consumer to a shopping list of the consumer.

### BACKGROUND

Consumers often reorder previously ordered products. Some products that are commonly reordered may include, for example, household items (e.g., cleaning supplies, soap, shampoo, toothpaste, etc.), office supplies (e.g., paper, ink, pens, pencils), prescription and over-the-counter medication, and dietary supplements just to name a few. Consumers typically order and reorder products on a website operated by a retail provider (e.g., Walmart/Sams Club) by browsing available products for the product of interest, adding the product of interest to a virtual shopping cart on the retail provider's web site, then proceeding to checkout by providing a payment method (e.g., credit card information) to purchase the product in the shopping cart.

One disadvantage of such website-based product ordering/reordering systems is that after consumers discard used products, the consumers typically have to again manually go through the time-consuming multi-step ordering process on the retail provider's website described above (i.e., browse for and select a product, add the product to the virtual shopping cart, and pay for the product in the virtual shopping cart at checkout). Another disadvantage of conventional retail websites is that, after discarding a product purchased from one retail provider, the consumers do not have a specific incentive to buy the replacement product form the retail provider from which the original product was purchased, but have a choice to go to any other retail provider to order the replacement product. This often leads the consumers to not reorder the product from the original online retail website, but to order the replacement product from a competing retail provider, disadvantageously result in a loss of customer for the retail provider from which the original product was purchased.

### BRIEF DESCRIPTION OF THE DRAWINGS

Disclosed herein are embodiments of systems, apparatuses and methods pertaining to systems and methods for adding a product discarded by a consumer to a shopping list of the consumer. This description includes drawings, wherein:

FIG. 1 is a diagram of a system for adding a product discarded by a consumer to a shopping list of the consumer in accordance with some embodiments.

FIG. 2 is a functional diagram of an exemplary electronic computing device usable with the system of FIG. 1 in accordance with several embodiments.

FIG. 3 is a flow chart diagram of a method of adding a product discarded by a consumer to a shopping list of the consumer in accordance with some embodiments.

FIG. 4 is a flow chart operational diagram of a process of adding a product discarded by a consumer to a shopping list of the consumer in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems and methods are provided for adding a product discarded by a consumer to a shopping list of the consumer based on consumer-specified product reorder settings.

In some embodiments, a receptacle for storing at least one product discarded by a consumer includes: a side wall defining: a receptacle opening for receiving the at least one product, a closed bottom end, and an interior cavity configured to retain the at least one product; a product detecting sensor configured to detect the at least one product proximate the receptacle opening; a product weight sensor configured to detect a weight of the at least one product retained in the interior cavity of the receptacle; and a control unit including a processor and in communication with the product detecting sensor and the product weight sensor. The control unit is configured to obtain sensor data from the product detecting sensor and the product weight sensor, identify the at least one product based on the obtained sensor data, and add the identified at least one product to a shopping list of the consumer.

In some embodiments, a method of adding at least one product discarded by a consumer to a shopping list of the consumer includes providing a receptacle for retaining the at least one product discarded by the consumer. The receptacle includes a side wall defining a receptacle opening for receiving the at least one product, a closed bottom end, an interior cavity configured to retain the at least one product, a product detecting sensor configured to detect the at least one product proximate the receptacle opening, a product weight sensor configured to detect a weight of the at least one product retained in the interior cavity of the receptacle, and a control unit including a processor and in communication with the product detecting sensor and the product weight sensor. The method further includes obtaining sensor data from the product detecting sensor and the product weight sensor, identifying the at least one product based on the obtained sensor data, and adding the identified product to the shopping list of the consumer.

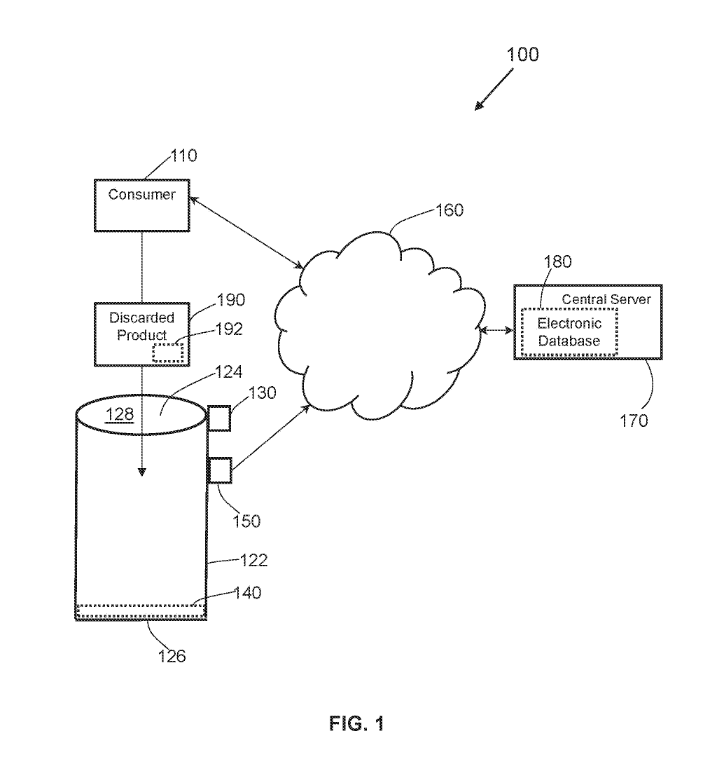

Referring to FIG. 1, one embodiment of a system 100 for assisting a consumer 110 in reordering (e.g., from a retail provider) products 190 discarded (i.e., placed into a trash receptacle) by the consumer 110. The retail provider may be any place of business having a brick-and-mortar physical location and/or a website accessible via the internet through which products 190 may be ordered by or reordered for the consumer 110. The products 190 discarded by the consumer 110 may be used products, waste products, or other products 190 that the consumer 110 decided to throw away and deposited into a trash receptacle. Exemplary products 190 that may be deposited by the consumer into a trash receptacle and as a result added to the virtual shopping cart of the consumer 110 and/or automatically reordered for the consumer 110 via the system 100 may include, but are not limited to general-purpose consumer goods as well as consumable items such as food items, dietary supplements, and medications.

The exemplary system 100 depicted in FIG. 1 includes a smart trash receptacle 120 available to the consumer 110 and configured to receive one or more products 190 discarded by the consumer 110. Such a smart trash receptacle 120 may be located in a kitchen of the consumer 110, or in another location at the residence or place of business of the consumer 110. The smart trash receptacle 120 includes a side wall 122 that defines a receptacle opening 124 for receiving one or more discarded products 190, a closed bottom end 126 opposite the receptacle opening 124, and an interior cavity 128 configured to retain the discarded products 190.

The exemplary smart trash receptacle 120 shown in FIG. 1 includes a product detecting sensor 130 coupled to the side wall 122 of the smart trash receptacle 120 proximate the receptacle opening 124. It will be appreciated that the location of the product detecting sensor 130 is shown in FIG. 1 by way of example only. For example, the product detecting sensor 130 may be coupled to the side wall 122 of the smart trash receptacle 120 such that the product detecting sensor is closer to the bottom end 126 than to the receptacle opening 124 of the smart trash receptacle 120. In some embodiments, the product detecting sensor 130 may be coupled to the side wall 122 of the smart trash receptacle 120 such that at least a portion of the product detecting sensor 130 is positioned in the receptacle opening 124 and/or in the interior cavity 128. In other embodiments, the product detecting sensor 130 may be coupled to the side wall 122 of the smart trash receptacle 120 such that no portion of the product detecting sensor 130 is positioned in the receptacle opening 124 and no portion of the product detecting sensor 130 is positioned in the interior cavity 128.

The product detecting sensor 130 may be detachably or non-detachably coupled to the side wall 122 of the smart trash receptacle 120. For example, the product detecting sensor 130 may be attached to an exterior, interior, or top surface of the side wall 122 such that the product detecting sensor 130 may be detached from the side wall 122 by the consumer 110 when desired. Alternatively, the product detecting sensor 130 may be either attached to an exterior, interior, or top surface of the side wall 122, or incorporated into the structure of the side wall 122 such that the product detecting sensor 130 may not be detached from the side wall 122 without damaging the side wall 122 and/or the product detecting sensor 130.

The product detecting sensor 130 may be a motion-detecting sensor, a photo sensor, a radio frequency identification (RFID) sensor, an optical sensor, a barcode sensor, a digital camera sensor, or a spectrometric sensor. In one embodiment, the product detecting sensor 130 includes a digital camera sensor configured to snap a still photo of the product 190 during the movement of the product 190 toward the receptacle opening 124, and to transmit a signal including the still photo of the product 190 to a control unit 150, discussed in more detail below, which is configured to identify the product 190 based on the still photo snapped by the digital camera sensor of the product detecting sensor 130. In an embodiment, a video clip of the product 190 moving toward the receptacle opening 124 may be recorded by the product detecting sensor 130, enabling the control unit 150 to identify the product 190 using video recognition.

In some embodiments, the product detecting sensor 130 includes a first sensor configured to detect movement of a product 190 being discarded by the consumer 110 toward the receptacle opening 124 of the smart trash receptacle 120, and a second sensor configured to scan the overall shape of the product 190 and/or scan product identifying indicia 192 located on the product 190 when the product 190 is proximate the receptacle opening 124 and/or otherwise within the detecting range of the product detecting sensor 130. In one exemplary embodiment, the first sensor is configured to activate the second sensor in response to detection, by the first sensor, of the movement of the product 190 toward the receptacle opening 124. In such an embodiment, the second sensor may be inactive until being activated by the first sensor, thereby conserving battery power that would otherwise be consumed if the second sensor were in constant operation.

The smart trash receptacle 120 shown in FIG. 1 includes a product weight sensor 140 coupled to the side wall 122 of the smart trash receptacle 120 proximate the bottom end 126 of the smart trash receptacle 120. The product weight sensor 140 is configured to detect a weight of the product 190 placed by the consumer 110 into the interior cavity 128 of the smart trash receptacle 120. In some embodiments, the product weight sensor 140 continuously monitors the weight of the products 190 in the interior cavity 128 of the smart trash receptacle 120 and can determine the weight of a product 190 newly added to the interior cavity 128 by calculating the difference between the total weight prior to the addition of the new product 190 and the total weight after the addition of the new product 190.

The smart trash receptacle 120 shown in FIG. 1 further includes a processor-based control unit 150 (e.g., microcontroller). The control unit 150 is configured for communication with the product detecting sensor 130 and the product weight sensor 140. In some embodiments, the control unit 150 is configured to obtain sensor data from the product detecting sensor 130 and the product weight sensor 140, identify the product 190 based on the obtained sensor data, and add the identified product 190 to a virtual shopping list of the consumer 110. While FIG. 1 shows the control unit 150 and the product detecting sensor 130 as two separate and distinct physical units, it will be appreciated that the control unit 150 may be configured as one physical unit incorporating one or more product detecting sensors 130.

The product weight sensor 140 of the smart trash receptacle 120 can cooperate with the product detecting sensor 130 in that the product weight sensor 140, based on the calculated weight of a product newly added to the interior cavity 128, may facilitate a more accurate identification of the discarded product 190 by the control unit 150. For example, if the control unit 150 determines, based on still image, video, or spectrometric data obtained from the product detecting sensor 130 that the product 190 discarded into the interior cavity 128 of the smart trash receptacle 120 is a bag of potato chips, the control unit 150 may reverse that determination after receiving weight data from the product weight sensor 140 indicating that the weight of the product 190 is 3 pounds, which is not a normal weight for a bag of potato chips.

The exemplary system 100 shown in FIG. 1 includes a central server 170 in two-way communication with the control unit 150 via a network 160, which may be a wired (DSL, cable, or the like) or wireless (Wi-Fi, cellular, or the like) network. The central server 170 may be implemented as one server at one location (e.g., at the retail provider's brick-and-mortar retail facility or at a location specifically dedicated to storage of retail provider's website servers). Alternatively, the central server 170 may be implemented as multiple interconnected servers stored at one or more locations. While FIG. 1 shows that the control unit 150 is in one-way communication with the central server 170 via the network 160, it will be appreciated that the control unit 150 and central server 170 may be configured for two-way communication via the network 160. Likewise, the control unit 150 may be configured for communicating directly with the central server 170 via the network 160 as shown in FIG. 1, or configured for communicating with the central server 170 indirectly via one or more intermediate communication devices.

In the embodiment shown in FIG. 1, the central server 170 may include an electronic database 180. The electronic database 180 may be configured to store information associated with a consumer 110 who orders and/or reorders products 190 from the retail provider and may relate to personal information of the consumer 110 and/or product order history of the consumer 110, and/or virtual shopping cart of the consumer 110, and/or product reorder settings of the consumer, and/or other information of interest to the consumer 110. It will be appreciated that the electronic database 180 on the central server 170 may also store information pertaining to the inventory of products 190 available to the consumer 110 for purchase or reorder from the retail provider and information pertaining to virtual shopping carts of the consumer 110 when ordering and/or reordering products 190 from the retail provider. While the central server 170 is illustrated in FIG. 1 as including one electronic database 180, it will be appreciated that the central server 170 may include or be connected to two or more separate electronic databases (e.g., one electronic database configured to store consumer information and one electronic database configured to store product inventory information.) The electronic database 180 may be stored, for example, on non-volatile storage media (e.g., a hard drive, flash drive, or removable optical disk) internal or external to the central server 170, or internal or external to computing devices separate and distinct from the central server 170.

In some embodiments, the processor of the control unit 150 is programmed to identify the discarded product 190 based on sensor data obtained from the product weight sensor 140 when the sensor data obtained from the product detecting sensor 130 alone is determined by the processor of the control unit 150 to be insufficient to accurately identify the product 190. In some embodiment, when the sensor data obtained from the product detecting sensor 130 and the product weight sensor 140 is insufficient to identify the product 190, the control unit 150 is configured to query the consumer 110 to respond by identifying the product 190. Such a query by the control unit 150 to the consumer 110 may be an audible spoken phrase (i.e., “is the product you discarded a bag of potato chips?”) or may be an electronic message sent to an electronic device (e.g. smartphone) of the consumer 110.

In some embodiments, after the identified discarded product 190 is added to a shopping cart of the consumer 110, the control unit 150 of the smart trash receptacle 120 (or the central server 170) is configured to transmit a signal including an electronic message (i.e., personal alert) including a query to an electronic device of the consumer 110, asking the consumer to respond to the query by indicating whether the identified product 190 added (e.g., by the control unit 150 or central server 170) to the virtual shopping cart (i.e., shopping list) of the consumer 110 is acceptable to the consumer 110. Such an electronic message or personal alert may include a query for the consumer 110 asking the consumer 110 to respond by indicating whether the consumer 110 is willing to accept one or more substitute products 190 instead of the product 190 added to the shopping list of the consumer, a clickable link to the substitute product 190, a picture of the substitute product 190, and/or a video of the substitute product 190. For example, if the consumer 110 discarded a product 190 not because the consumer 110 used/consumed all of the product 190, but because the consumer 110 did not like the product (e.g., taste), the consumer 110 is not likely to be interested in reordering this product 190, but may be interested in trying one or more substitute products 190 (e.g., different brand).

In some embodiments, the electronic message or personal alert transmitted by the control unit 150 (or central server 170) further includes a query for the consumer 110 asking the consumer 110 to respond by indicating whether the consumer 110 is willing to accept at least one complementary product 190 to the product 190 added by the control unit 150 (or central server 170) to the shopping list, a clickable link to the complementary product 190, a picture of the complementary product 190, and/or a video of the at least one complementary product 190. For example, if the consumer 110 discarded a box of crackers and an identical box of crackers has been added to the shopping list of the consumer 110, the consumer 110 may also be interested in a product complementary to the crackers (e.g., cheese).

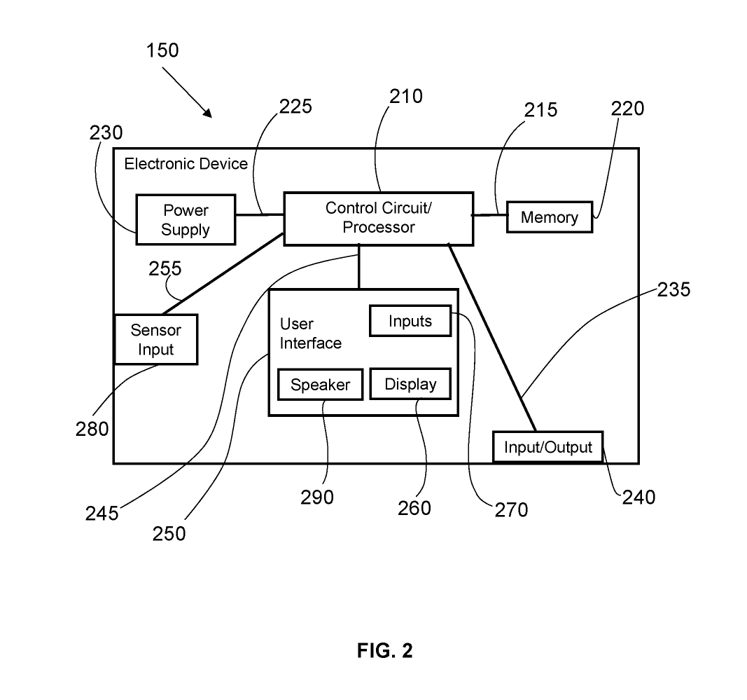

With reference to FIG. 2, an exemplary control unit 150 configured for use with the system 100 and methods described herein may include a control circuit 210 including a processor (for example, a microprocessor or a microcontroller) electrically coupled via a connection 215 to a memory 220 and via a connection 225 to a power supply 230. The control circuit 210 of the control unit 150 is also electrically coupled via a connection 235 to an input/output 240 that can receive signals from the central server 170 (e.g., data from the electronic database 180) or from any other source that can communicate with the control unit 150 (e.g., smart phone of a consumer 110) via a wired or wireless connection. The input/output 240 of the control unit 150 can also send signals to the central server 170 (e.g., electronic data including an identified product 190 discarded by the consumer 110 into the smart trash receptacle 120), or to any other device in communication with the control unit 150.

In an embodiment (as in FIG. 1) where the product detecting sensor 130 and the control unit 150 are implemented as two physically distinct units in communication with each other, the control unit 150 in FIG. 2 includes sensor inputs 280 configured to receive signals from the separate product detecting sensor 130. For example, the sensor input 280 of the control unit 150 may be configured to receive electronic data from a motion-detecting sensor, a photo sensor, a radio frequency identification (RFID) sensor, an optical sensor, a barcode sensor, a digital camera sensor, and a spectrometric sensor.

Optionally, instead of receiving sensor data from a separate product detecting sensor 130, the control unit 150 may physically incorporate or be electrically coupled to the product detecting sensor 130. For example, the control unit 150 may incorporate a product detecting sensor 130 such as a reader configured to detect and/or read information on an identifying indicia 192 located on the discarded product 190 when the product 190 is in direct proximity to the control unit 150 (such as when the product 190 approaches and/or passes through the receptacle opening 124). Such a reader may be a radio frequency identification (RFID) reader, an optical reader, a barcode reader, or the like.

In the embodiment shown in FIG. 2, the control circuit 210 of the control unit 150 is electrically coupled via a connection 245 to a user interface 250, which may include a visual display or display screen 260 (e.g., LED screen) and/or inputs 270 that provide the user interface 250 with the ability to permit a consumer 110 to manually control the control unit 150 by inputting commands via touch-screen and/or button operation and/or voice commands to, for example, add one or more products to the shopping cart of the consumer 110; purchase one or more products added to the shopping cart; and/or configure settings of the consumer 110 that control the reordering of products 190 from a retail provider using the system 100.

In some embodiments, the display screen 260 of the control unit 150 is also configured to permit the user to see various graphical interface-based menus, options, and/or alerts that may be displayed to the consumer 110 by the control unit 150 in connection with the consumer 110 modifying and/or updating the product reorder settings of the consumer 110 or other information. The inputs 270 of the control unit 150 may be configured to permit the consumer 110 to navigate through the on-screen menus on the control unit 150. It will be appreciated that the display screen 260 may, in some embodiments, be configured as both a display screen and an input 270 (e.g., a touch-screen that permits the consumer 110 to press directly on the display screen 260 to enter text and/or execute commands.)

The user interface 250 of the control unit 150 may also include a speaker 290 that may provide audible feedback (e.g., alerts) to the consumer 110. For example, in some embodiments, the control unit 150 may be programmed to generate an audible query to the consumer via the speaker 290, prompting the consumer 110 to verbally confirm the identification of the product 190 by the control unit 150. In response to such an audible query, the consumer 110 may respond verbally (or manually via display screen 260 or inputs 270) by confirming the identity of the product 190, or by correctly identifying the identity of the discarded product 190.

In some embodiments, the input/output 240 of the control unit 150 is a transmitter configured to transmit (e.g., over a wired or wireless connection) a signal including an identification of the discarded product 190 added by the control unit 150 to the shopping list of the consumer 110 to the central server 170, which then records and/or updates the shopping list of the consumer in the electronic database 180. In some embodiments, the central server 170 is configured to add the discarded product 190 to a shopping list or virtual shopping cart of the consumer 110 in response to receiving electronic data identifying the discarded product 190 from the control unit 150 of the smart trash receptacle 120. In some embodiments, the control unit 150 posts the electronic data on the central server 170 via a hypertext transfer protocol (HTTP)-based application programming interface (API).

In some embodiments, the central server 170 is programmed to query the electronic database 180 to determine whether the product 190 may be reordered for the consumer 110 and when the central server 170 receives a confirmation (e.g., from the electronic database 180) that the product 190 may be reordered, the central server 170 automatically reorders the product 190 for the consumer 110. Such automatic reordering may be enabled by way of preferences of the consumer 110 stored in the electronic database 180, or by way of programming the central server 170 to automatically reorder the product 190 if the product 190 added to the virtual shopping cart of the consumer 110 is determined to be reorderable. In other embodiments, after adding a product 190 to the virtual shopping cart of the consumer, the central server 170 is programmed to generate an electronic personal alert for the consumer 110 in connection with the product 190 added at the central server 170 to the virtual shopping cart of the consumer 110. Some exemplary electronic personal alerts that may be sent to the consumer 110 from the central server 170 and displayed on an electronic device owned by the consumer 110 (e.g., mobile phone, tablet, laptop, or the like) may include but are not limited to text messages, electronic mail (e-mail) messages, and/or voice mail messages. The consumer 110 may then respond to the electronic personal alert by either confirming that the product 190 added to the virtual shopping cart of the consumer 110 should be ordered, or by deleting the product 190 from the virtual shopping cart of the consumer 110.

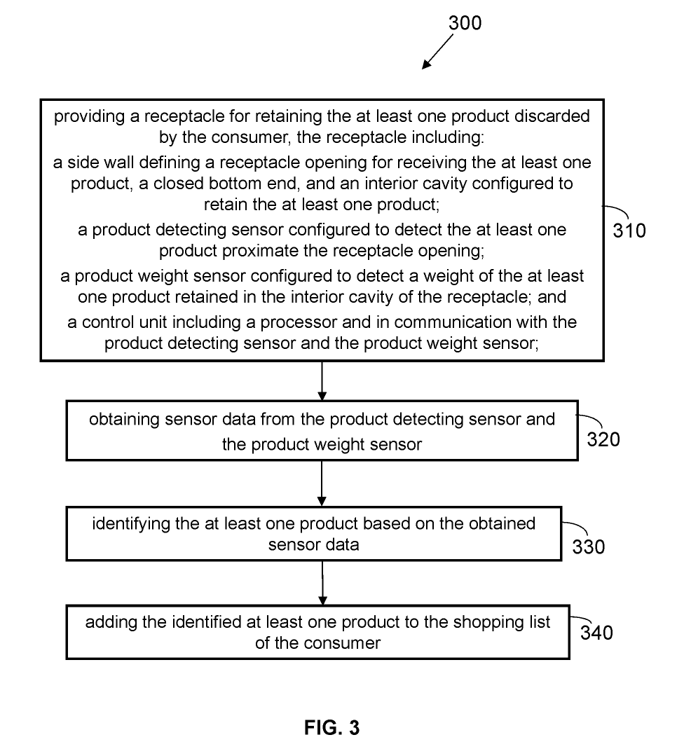

Referring to FIG. 3, an exemplary method 500 of assisting a consumer 110 of adding at least one product 190 discarded by the consumer 190 to a shopping list of the consumer 110 is shown. Step 310 of the exemplary method 300 shown in FIG. 3 includes providing a smart trash receptacle 120 for retaining one or more products 190 discarded by the consumer 110. In the method of FIG. 3, the smart trash receptacle 120 includes: a side wall 122 defining a receptacle opening 124 for receiving the product 190, a closed bottom end 126, an interior cavity 128 configured to retain the product 190, a product detecting sensor 130 configured to detect the product 190 proximate the receptacle opening 124, a product weight sensor 140 configured to detect a weight of the product 190 retained in the interior cavity 128 of the receptacle 120, and a control unit 150 including a processor and in communication with the product detecting sensor 130 and the product weight sensor 140.

The exemplary method 300 depicted in FIG. 3 further includes obtaining sensor data from the product detecting sensor 130 and the product weight sensor 140 (step 320). As described above, such sensor data may include barcode, RFID, photo, video, spectrometric and/or weight data associated with the product 190 as detected by the product detecting sensor 130 and/or the product weight sensor 140 when the product 190 is placed in proximity to the product detecting sensor 130 and/or into the interior cavity 128 of the smart trash receptacle 120.

The exemplary method 300 of FIG. 3 further includes identifying the product 190 based on the obtained sensor data (step 330) and adding the identified product 190 to the shopping list (i.e., virtual shopping cart) of the consumer 110 (step 340). The step of identifying the product 190 based on the obtained sensor data may occur at the control unit 150 or at the central server 170. Similarly, the step of adding the identified product 190 to the shopping list of the consumer may occur at the control unit 150 or at the central server 170.

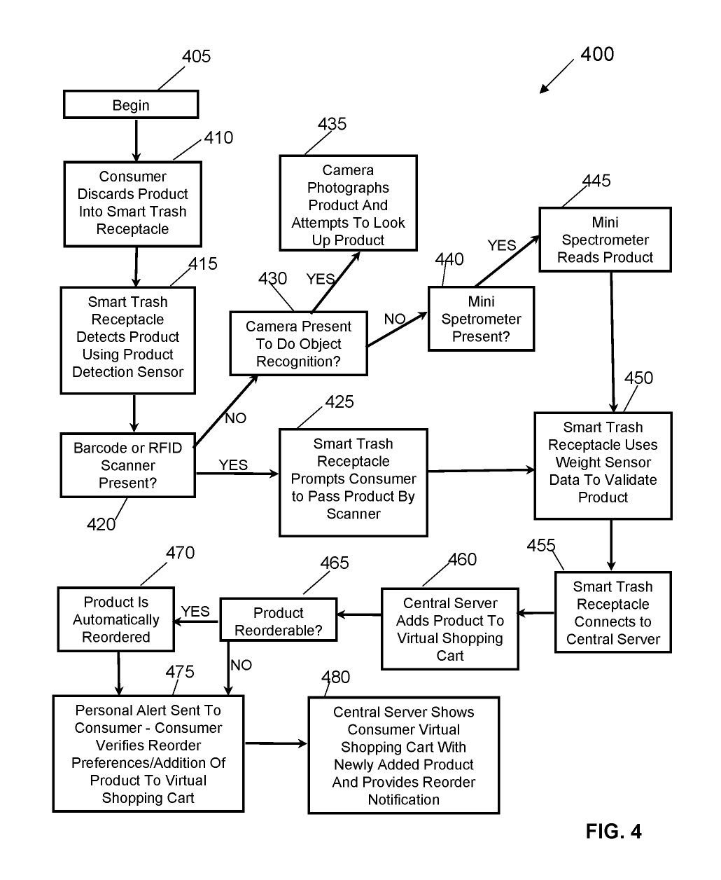

A flow chart illustrating an exemplary embodiment of a process 400 for adding products 190 discarded by a consumer 110 to a virtual shopping cart of the consumer 110 is depicted in FIG. 4. The system 300 may be available via desktop-based electronic computing devices using desktop-based (e.g., Windows or Mac) operating systems, or via mobile-based electronic computing devices using mobile-based operating systems such as IOS and Android.

As shown in FIG. 4, the process 400 may be initiated (step 405) when a consumer 110 discards a consumed or unwanted product 190 by throwing or dropping the product 190 into a smart trash receptacle 120 (step 410). When such a product 190 is in proximity to the smart trash receptacle 120, and in some embodiments, in proximity to or partially within the receptacle opening 124, the smart trash receptacle 120 detects movement and/or presence of the product 190 near the smart trash receptacle 120. Such detection is enabled by a product detecting sensor 130 as described above (step 415). The product detecting sensor 130, after detecting the movement and/or presence of the product 190 near the smart trash receptacle 120, can scan the product 190 as the product 190 approaches the smart trash receptacle 120 to facilitate identification of the product 190. As described above, the product detecting sensor 130 may facilitate identification of the product 190 in conjunction with the product weight sensor 140.

In embodiments where the product detecting sensor 130 includes a barcode or RFID scanner (step 420), the control unit 150 may generate an audible or visual prompt (e.g., a beep or other alert sound, flashing light or lights, or the like) to the consumer 110 to notify the consumer 110 to pass the identifying indicia 192 (i.e., a barcode or RFID code) of the product 190 by the product detecting sensor 130 to enable the product detecting sensor 130 to identify the product 190 (step 425).

In some embodiments, the product detecting sensor 130 may include a digital camera sensor that enables photo and video recognition of the product 190 (step 430). For example, the product detecting sensor 130 may include a digital camera that snaps digital images of the product 190, enabling the control unit 150 of the smart trash receptacle 120 to analyze the snapped still image, for example, by matching the still image of the product 190 snapped by the product detecting sensor 130 against images of known products 190 stored in the electronic database 180 or another electronic databases (step 435).

In some embodiments, the product detecting sensor 130 includes a spectrometric sensor (step 440) configured to analyze the product 190 as the product passes by the product detecting sensor 130, generating spectrometric data that may enable the control unit 150 to analyze the spectrometric data against spectrometric values of known products 190 stored in an electronic database in communication with the control unit 150 (step 445).

After the product 190 is identified or predicted in steps 415-445, the weight data obtained from the weight sensor 140 may be used to validate the identification of the product 190 by the control unit 150, as described above (step 450). Notably, weight sensor data obtained from the weight sensor 140 may not only facilitate and/or confirm identification of the product 190 by the control unit 150, but may also provide an indication of whether the consumer 110 discarded the product packaging (e.g., bag or carton) when full of product 190, half-full, or empty. In some embodiments, the control unit 150 is programmed to interpret weight sensor indicating that product packaging was discarded by the consumer 110 when empty as an indication that the consumer 110 liked the product 190, increasing the likelihood that the consumer 110 would reorder that product 190 if the product 190 were added (by the control unit 150 or central server 170) to the virtual shopping cart of the consumer 110. Conversely, the control unit 150 may interpret weight sensor indicating that product packaging was discarded by the consumer 110 when full or nearly full as an indication that the consumer 110 did not like the product, decreasing the likelihood that the consumer 110 would reorder that product 190 if the product 190 were added to the virtual shopping cart of the consumer 110.

In the embodiment shown in FIG. 4, after the product 190 discarded by the consumer 110 is identified, the control unit 150 transmits electronic data identifying the discarded product 190 to the central server 170 via the network 160 (step 455). The electronic data transmitted from the control unit 150 of the smart trash receptacle 120 includes an identifier that uniquely identifies the control unit 150 and thus the consumer 110 associated with that control unit 150 to the central server 170. In response to receiving the data from the control unit 150 of the smart trash receptacle 120, the central server 170 adds the discarded product 190 to the shopping list of the consumer 110 (step 460). Then, the central server 170 queries the electronic database 180 to confirm that the discarded product 190 is reorderable (step 465) and, if the discarded product 190 is reorderable, the central server 170 automatically processes a reorder for the discarded product 190 for the consumer 110 (step 470).

In some embodiments, the central server 170 may send a personal alert as described above to an electronic device (e.g., smart phone) of the consumer 110 to notify the consumer 110 that the product 190 discarded by the consumer 110 has been added to a virtual shopping cart of the consumer 110, and to query the consumer to confirm or decline the addition of this product 190 to the virtual shopping cart (step 475). As discussed above, based on the preferences of the consumer 110 stored in the electronic database 180 on the central server 170, the central server 170 may automatically reorder the product 190 without sending a personal alert to the electronic device of the consumer 110 to request the consumer 110 to approve the reorder.

In certain situations, the consumer 110 may not want to reorder a discarded product 190, for example, when the consumer 110 discarded the product 190 into the smart trash receptacle 120 not because the product 190 was fully consumed, but because the product 190 was deemed by the consumer 110 unsuitable for consumption for any number of reasons. In such situations, the consumer 110 is permitted to respond to the consumer alert sent by the central server 170 by declining to add the product 190 to the shopping list of the consumer 110. Conversely, if the consumer 110 responds to the personal alert sent by the central server 170 by confirming the addition of the product 190 to the shopping list of the consumer 110, the central server 170 may then reorder the product 190 and provide the consumer 110 with a notification that the product 190 has been reordered (step 480). The consumer 110 may then log off the central server 170 and close the graphical interface (e.g., internet browser or mobile app) that was used for logging into the account of the consumer 110 and viewing the personal alert and/or the virtual shopping cart.

In some embodiments, after clicking on a link and/or otherwise interacting with a menu option in the consumer alert received by the consumer 110 from the central server 170, a consumer 110 having a previously established account with a retail provider may initially connect to the central server 170 via dot.com access (e.g., via the retail provider's dedicated website) by using a unique identification (ID), for example, a unique login/password combination selected by the consumer 110 when establishing the consumer's online account with the retail provider. Generally, after a consumer 110 initially sets up an account with the retail provider, the personal information of the consumer 110 and electronic data associated with product orders and reorders by the consumer 110 may be stored in the electronic database 180 for subsequent retrieval by the central server 170 (e.g., in response to a login request by the consumer 110). Upon verification of the identity of the consumer 110 (e.g., by verifying the username/password data entered by the consumer 110 against username/password data in the profile of the consumer 110 stored in the electronic database 180), the central server 170 may then associate the profile of the consumer 110 with the identity of the consumer 110, retrieve the consumer profile from the electronic database 180, and retrieve the virtual shopping cart of the consumer 110 stored in the electronic database 180.

In some embodiments, the virtual shopping cart of the consumer 110 is a software-implemented graphical interface configured to be displayed on an electronic computing device of the consumer 110 and may include one or more menu options and/or sub-interfaces that may permit the consumer 110 to select the products 190 to be ordered by or for the consumer 110 via the central server 170. In some embodiments, the virtual shopping cart may be configured to permit the consumer 110, while not being physically present at the brick-and-mortar retail facility of the retail provider, to add a product 190 of interest to the consumer's virtual shopping cart and/or product reorder list by accepting a query option in the personal alert sent by the central server 170, or by manually entering identifying information associated with an alternative product 190 that the consumer 110 prefers to add to the virtual shopping cart.

In some embodiments, the shopping cart of the consumer 110 and/or the product reorder shopping list of the consumer 110 may be stored in the electronic database 180 on the central server 170. As discussed above, the virtual shopping cart may be modified by the consumer 110 by accepting the addition of one or more products 190 previously ordered and discarded by the consumer 110 to the product reorder shopping list or by removing such products 190 from the product reorder shopping list. For example, when the consumer 110 modifies the consumer's product reorder shopping list (i.e., virtual shopping cart), the central server 170 may update the electronic database 180 to reflect the changes made by the consumer 110.

In some embodiments, the software-implemented graphical interface available to the consumer 110 via the central server 170 may permit the consumer 110 to set and modify various product reorder settings after a discarded product 190 is added to a virtual shopping cart of the consumer. As discussed above, the electronic database 180 on the server 170 may store all such preferences set by the consumer 110. For example, the product reorder settings may enable the consumer 110 to: set a predetermined number of products 190 to be automatically reordered via the system 100; set specific alternative products 190 to be automatically ordered for the consumer 110 via the system 100 in the event that product 190 discarded by the consumer 190 and added to the consumer's virtual shopping cart is not available (e.g., out-of-stock, discontinued, or the like); set specific products 190 that are complementary to the discarded product 190 that the consumer 110 wants to order when reordering the discarded product 190, as well as various other options that enable the consumer 110 to customize and personalize the reordering of the products 190 based on the needs of the consumer 100. The reorder settings of the consumer 110 may likewise be set by the consumer 110 to block automatic reordering of products 190 for the consumer 110, and to require the central server 170 to send a personal alert to the electronic device of the consumer 110 to request that the consumer 110 confirm the addition of a discarded product 190 to the virtual shopping cart of the consumer 110.

The systems and methods described herein provide for easy and/or automatic reordering of products discarded by the consumers, enabling the consumers to automatically reorder a product that they place into a trash can without having to connect to the internet and/or log into a website. In addition, the systems and methods described herein advantageously enable retail providers to retain consumers by tying the discarding of a product by the consumer to a reorder of the same, substitute, and/or complementary product from a specific retailer provider, enabling the retail provider to retain customers who previously ordered from the retail provider. In addition, the systems and methods described herein may advantageously provide retail providers with data indicating product usage trends of consumers, enabling the retail providers to personalize product offerings to the consumers based on the consumers' product usage. As such, the systems and methods described herein may advantageously save consumers time in reordering products and may enable retail providers to retain their customers and increase their revenue by retaining customers and monetizing known consumer product usage trends.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A receptacle for storing at least one product discarded by a consumer, the receptacle comprising:
a side wall defining: a receptacle opening for receiving the at least one product, a closed bottom end, and an interior cavity configured to retain the at least one product;
a product detecting sensor configured to detect the at least one product proximate the receptacle opening;
a product weight sensor configured to detect a weight of the at least one product retained in the interior cavity of the receptacle; and
a control unit including a processor and in communication with the product detecting sensor and the product weight sensor, the control unit being configured to: obtain sensor data from the product detecting sensor and the product weight sensor, identify the at least one product based on the obtained sensor data, and add the identified at least one product to a shopping list of the consumer.

2. The receptacle of claim 1, wherein the product detecting sensor is coupled to the side wall proximate the receptacle opening and the product weight sensor is coupled to the side wall proximate the bottom end of the receptacle.

3. The receptacle of claim 1, wherein the product detecting sensor includes a first sensor configured to detect movement of the at least one product toward the receptacle opening and a second sensor configured to scan product identifying indicia located on the at least one product when the at least one product is proximate the receptacle opening, the first sensor being configured to activate the second sensor in response to detection of the movement of the at least one product toward the receptacle opening.

4. The receptacle of claim 1, wherein the product detecting sensor includes at least one of: a motion-detecting sensor, a photo sensor, a radio frequency identification (RFID) sensor, an optical sensor, a barcode sensor, a digital camera sensor, and a spectrometric sensor.

5. The receptacle of claim 4, wherein the digital camera sensor is configured to snap a still photo of the at least one product during the movement of the at least one product toward the receptacle opening, and to transmit a signal including the still photo of the at least one product to the control unit, the processor of the control unit being configured to identify the at least one product based on the still photo obtained from the digital camera sensor.

6. The receptacle of claim 1, wherein the processor of the control unit is programmed to identify the at least one product based on sensor data obtained from the product weight sensor when sensor data obtained from the product detecting sensor alone is determined by the processor of the control unit to be insufficient to identify the at least one product, and when the sensor data obtained from the product detecting sensor and the product weight sensor is insufficient to identify the at least one product, the control unit is configured to transmit a signal including an electronic message to an electronic device of the consumer, the electronic message asking the consumer to respond by identifying the at least one product.

7. The receptacle of claim 1, wherein the control unit is further configured transmit a signal including an electronic message to an electronic device of the consumer, the electronic message including a query for the consumer asking the consumer to respond by indicating whether the identified at least one product added by the control unit to the shopping list of the consumer is acceptable to the consumer, and wherein the consumer is permitted to delete the identified at least one product from the shopping list via a prompt in the electronic message if the identified at least one product added by the control unit to the shopping list of the consumer is not acceptable to the consumer.

8. The receptacle of claim 7, wherein the electronic message transmitted by the control unit further includes at least one of: a query for the consumer asking the consumer to respond by indicating whether the consumer is willing to accept at least one substitute product instead of the identified at least one product added by the control unit to the shopping list, a clickable link to the at least one substitute product, a picture of the at least one substitute product, and a video of the at least one substitute product.

9. The receptacle of claim 7, wherein the electronic message transmitted by the control unit further includes at least one of: a query for the consumer asking the consumer to respond by indicating whether the consumer is willing to accept at least one complementary product to the identified at least one product added by the control unit to the shopping list, a clickable link to the at least one complementary product, a picture of the at least one complementary product, and a video of the at least one complementary product.

10. The receptacle of claim 1, wherein the control unit includes a transmitter configured to transmit a signal including the identified at least one product added by the control unit to the shopping list of the consumer over a wireless connection to a server in communication with the control unit and configured to record the shopping list, the server being configured to automatically reorder the identified at least one product on the shopping list of the consumer based on at least one product reorder setting preset by the consumer.

11. A method of adding at least one product discarded by a consumer to a shopping list of the consumer, the method comprising:
providing a receptacle for retaining the at least one product discarded by the consumer, the receptacle including:
a side wall defining a receptacle opening for receiving the at least one product, a closed bottom end, and an interior cavity configured to retain the at least one product;
a product detecting sensor configured to detect the at least one product proximate the receptacle opening;
a product weight sensor configured to detect a weight of the at least one product retained in the interior cavity of the receptacle; and
a control unit including a processor and in communication with the product detecting sensor and the product weight sensor;
obtaining sensor data from the product detecting sensor and the product weight sensor;
identifying the at least one product based on the obtained sensor data; and
adding the identified at least one product to the shopping list of the consumer.

12. The method of claim 11, wherein the providing of the receptacle comprises coupling the product detecting sensor to the side wall proximate the receptacle opening and coupling the product weight sensor to the side wall proximate the bottom end of the receptacle.

13. The method of claim 11, further comprising providing the product detecting sensor with a first sensor configured to detect movement of the at least one product toward the receptacle opening and a second sensor configured to scan product identifying indicia located on the at least one product when the at least one product is proximate the receptacle opening, and further comprising activating the second sensor via the first sensor in response to detection of the movement of the at least one product toward the receptacle opening.

14. The method of claim 11, further comprising providing the product detecting sensor with at least one of: a motion-detecting sensor, a photo sensor, a radio frequency identification (RFID) sensor, an optical sensor, a barcode sensor, a digital camera sensor, and a spectrometric sensor.

15. The method of claim 14, further comprising:
configuring the digital camera sensor to snap a still photo of the at least one product during the movement of the at least one product toward the receptacle opening;
transmitting a signal including the still photo of the at least one product to the control unit; and
identifying the at least one product based on the still photo obtained from the digital camera sensor.

16. The method of claim 11, further comprising:
identifying the at least one product based on sensor data obtained from the product weight sensor when sensor data obtained from the product detecting sensor alone is determined by the processor of the control unit to be insufficient to identify the at least one product; and
when the sensor data obtained from the product detecting sensor and the product weight sensor is insufficient to identify the at least one product, transmitting a signal including an electronic message to an electronic device of the consumer, the electronic message asking the consumer to respond by identifying the at least one product.

17. The method of claim 11, further comprising:
transmitting a signal including an electronic message to an electronic device of the consumer, the electronic message including a query for the consumer asking the consumer to respond by indicating whether the identified at least one product added by the control unit to the shopping list of the consumer is acceptable to the consumer; and
permitting the consumer to delete the identified at least one product from the shopping list via a prompt in the electronic message if the identified at least one product added by the control unit to the shopping list of the consumer is not acceptable to the consumer.

18. The method of claim 17, further comprising transmitting the electronic message further including at least one of: a query for the consumer asking the consumer to respond by indicating whether the consumer is willing to accept at least one substitute product instead of the identified at least one product added by the control unit to the shopping list, a clickable link to the at least one substitute product, a picture of the at least one substitute product, and a video of the at least one substitute product.

19. The method of claim 17, further comprising transmitting the electronic message further including at least one of: a query for the consumer asking the consumer to respond by indicating whether the consumer is willing to accept at least one complementary product to the identified at least one product added by the control unit to the shopping list, a clickable link to the at least one complementary product, a picture of the at least one complementary product, and a video of the at least one complementary product.

20. The method of claim 11, further comprising:
transmitting, from the control unit, a signal including the identified at least one product added by the control unit to the shopping list of the consumer over a wireless connection to a server in communication with the control unit and configured to record the shopping list; and
automatically reordering, at the server, the identified at least one product on the shopping list of the consumer based on at least one product reorder setting preset by the consumer.
